(19) United States
(12) Patent Application Publication
(10) Pub. No.: US 2026/0118812 A1
(43) Pub. Date: Apr. 30, 2026

(54) SHEET PROCESSING APPARATUS AND IMAGE FORMING SYSTEM

(71) Applicant: CANON FINETECH NISCA INC., Saitama (JP)

(72) Inventor: MASAYUKI KOBAYASHI, Yamanashi (JP)

(21) Appl. No.: 19/367,912

(22) Filed: Oct. 24, 2025

(30) Foreign Application Priority Data
Oct. 30, 2024 (JP) 2024-190440

(51) Int. Cl. G03G 15/00

(52) U.S. Cl. CPC G03G 15/6544; G03G 2215/00556; G03G 2215/00717

(57) ABSTRACT

Disclosed is a sheet processing apparatus that includes: a stack tray having a stacking surface configured to stack the sheet bundle, a sensor configured to detect a height of an uppermost sheet of a sheet bundle stacked on the stacking surface, a lifting mechanism configured to lift up and down the stack tray based on an output of the sensor, a pressing member having a contact portion configured to elastically deform and contact an upper surface of the sheet bundle abutted against the abutting surface, wherein the control unit is configured to, while a plurality of sheet bundles composed of predetermined sheets are being continuously discharged, and in case the sheet bundle stacked on the stacking surface is removed such that the contact portion of the pressing member at the pressing position becomes separated from the stacking surface, repeatedly lift up the stack tray by a predetermined amount in response to a rotation command of the pressing member, in order to prevent the pressing member from being sandwiched between the stack tray and the abutting surface.

### BACKGROUND

### Field of the Technology

This invention relates to a sheet processing apparatus that performs a predetermined process on a sheet and discharges the processed sheet, and especially to a sheet processing apparatus in which a sheet pressing portion that presses a sheet discharged on a stacking portion can properly operate, and an image forming system equipped with the sheet processing apparatus.

### Description of the Related Art

Recently, a sheet processing apparatus is getting to be used by integrally assembled with an image forming apparatus, which not only discharges a sheet on which an image is formed by the image forming apparatus but also performs a staple process and a folding process for a sheet on which an image has been formed.

In such a sheet processing apparatus, sheets are discharged and stacked on the sheet stacking tray for each sheet bundle subjected to a staple process. In order that a sheet bundle that has already been discharged on the sheet stacking tray is not pushed out by a succeeding a sheet bundle to be discharged, a pressing portion is provided that presses an upper surface of the sheets that have already been stacked (for example, disclosed in Japanese Patent Application Laid-open No. 2023-20999). For example, as shown in FIG. 15, the pressing member 500 that is a member such as a rubber plate that can be elastically deformed is rotatably provided. Each time the sheet bundle 502 is discharged on the sheet stacking tray 501, the pressing member 500 is rotated and presses the upper surface of the discharged sheets so that the sheets that have already been stacked are not pushed out.

The sheet stacking tray 501 is configured to be able to be lifted up and down along the vertical surface 503. When a predetermined number of sheets are discharged on the sheet stacking tray 510 in a sheet receiving position, the sheet stacking tray 501 is lifted down such that the uppermost sheet of the sheets stacked on the sheet stacking tray 501 is in the sheet receiving position. Further, when the sheets stacked on the sheet stacking tray 501 are removed, the sheet stacking tray is lifted up to the sheet receiving position. As a result, the pressing member 500 can precisely press the uppermost sheet of the sheets discharged on the sheet stacking tray.

Further, the sheet surface detection sensor 504 is provided for locating to the sheet receiving position the upper surface of the sheet stacking tray 501 or the upper surface of the uppermost sheet stacked on the sheet stacking tray 501. The sheet surface detection sensor 504 is in on-state when the sheet stacking tray 501 or a sheet is present in the detecting position of the sensor, and is in off-state when the sheet stacking tray 501 and a sheet are absent in the detecting position of the sensor. The sheet stacking tray 501 is lifted up and down according to an output of the sheet surface detection sensor 504.

In the above described configuration for lifting the sheet stacking tray 501 up and down, as shown in FIG. 16A, when the sheet surface detection sensor 504 is in off-state after a predetermined number or more sheets are discharged, the sheet stacking tray 501 is lifted up until the sheet surface detection sensor 504 becomes in on-state since the sheets on the sheet stacking tray 501 have been removed. In this case, when the discharge of the sheets is continued, the pressing member 500 is located at an angle of the pressing position (tip being directed downward) for discharging the next sheets.

The pressing member 500 is made by a rubber plate with a thickness of several millimeters. The gap 505 is formed between the sheet stacking tray 501 and the vertical surface 503 in order to smoothly lift up and down the sheet stacking tray 501. In this case, if the sheet stacking tray 501 is lifted up all at once to the position where the sheet surface detection sensor 504 becomes in on-state, an abutting portion of the pressing member 500 that is elastically deformed may be nipped between the sheet stacking tray 501 and the vertical surface 503 as shown in FIG. 16B. When the pressing member 500 is nipped in the gap 505, the pressing member 500 cannot be rotated, which may cause a discharge operation defect.

### SUMMARY

This disclosure is directed to provide a sheet processing apparatus that enables the sheet pressing portion to rotate even when the sheet stacking tray is lifted up after the sheets are removed from the sheet stacking tray in a case where the discharge of sheets is continued, and an image forming system with sheet processing apparatus.

An aspect of the present disclosure is a sheet processing apparatus comprising:

a binding portion configured to perform a binding process to a sheet bundle;

a discharge portion configured to discharge the sheet bundle binded by the binding portion;

a stack tray having a stacking surface configured to stack the sheet bundle discharged by the discharge portion;

an abutting surface configured to receive one end of the sheet bundle discharged onto the stacking surface

a sensor configured to detect a height of an uppermost sheet of a sheet bundle stacked on the stacking surface;

a lifting mechanism configured to lift up and down the stack tray such that the height of the uppermost sheet of a sheet bundle on the stacking surface falls within a predetermined range, based on an output of the sensor;

a pressing member having a contact portion configured to elastically deform and contact an upper surface of the sheet bundle abutted against the abutting surface, and configured to rotate to a pressing position to press the upper surface of the sheet bundle;

a rotating mechanism configured to rotate the pressing member;

a control unit configured to control the lifting mechanism and the rotating mechanism;

wherein the control unit is capable of executing control such that, while a plurality of sheet bundles composed of predetermined sheets are being continuously discharged, and in case the sheet bundle stacked on the stacking surface is removed such that the contact portion of the pressing member at the pressing position becomes separated from the stacking surface,

the stack tray is repeatedly lifted by a predetermined amount in accordance with a command to rotate the pressing member, such that the height of the uppermost sheet of the sheet bundle on the stacking surface falls within a predetermined range, in order to prevent the pressing member from being sandwiched between the stack tray and the abutting surface.

Further features of the present invention will become apparent from the following description of exemplary embodiments with reference to the attached drawings.

### BRIEF DESCRIPTION OF THE DRAWINGS

FIG. 1 is a schematic diagram showing the overall configuration of an image forming system with a sheet processing apparatus.

FIG. 2 is a diagram showing a perspective view of the sheet processing apparatus.

FIG. 3 is an explanatory diagram showing the configuration of the sheet processing apparatus.

FIGS. 4A, 4B and 4C are explanatory diagrams showing sheet aligning and binding operations.

FIG. 5 is an explanatory diagram showing a lifting mechanism of the sheet stacking tray.

FIGS. 6A and 6B are explanatory diagrams showing a driving mechanism of a sheet pressing paddle.

FIG. 7 is a block diagram showing a controlling configuration of the image forming system.

FIG. 8 is a flowchart showing a sheet discharge operation.

FIGS. 9A and 9B are explanatory diagrams showing a sheet discharging operation to the sheet stacking tray.

FIGS. 10A and 10B are explanatory diagrams showing a sheet discharging operation to the sheet stacking tray.

FIG. 11 is an explanatory diagram showing a sheet discharging operation to the sheet stacking tray.

FIGS. 12A, 12B and 12C are explanatory diagrams showing a sheet discharging operation to the sheet stacking tray.

FIG. 13 is an explanatory diagram showing a sheet discharging operation to the sheet stacking tray.

FIGS. 14A and 14B are explanatory diagrams showing a sheet discharging operation to the sheet stacking tray..

FIG. 15 is an explanatory diagram showing a prior art.

FIGS. 16A and 16B are explanatory diagrams showing a prior art.

### DESCRIPTION OF THE EMBODIMENTS

### First Embodiment

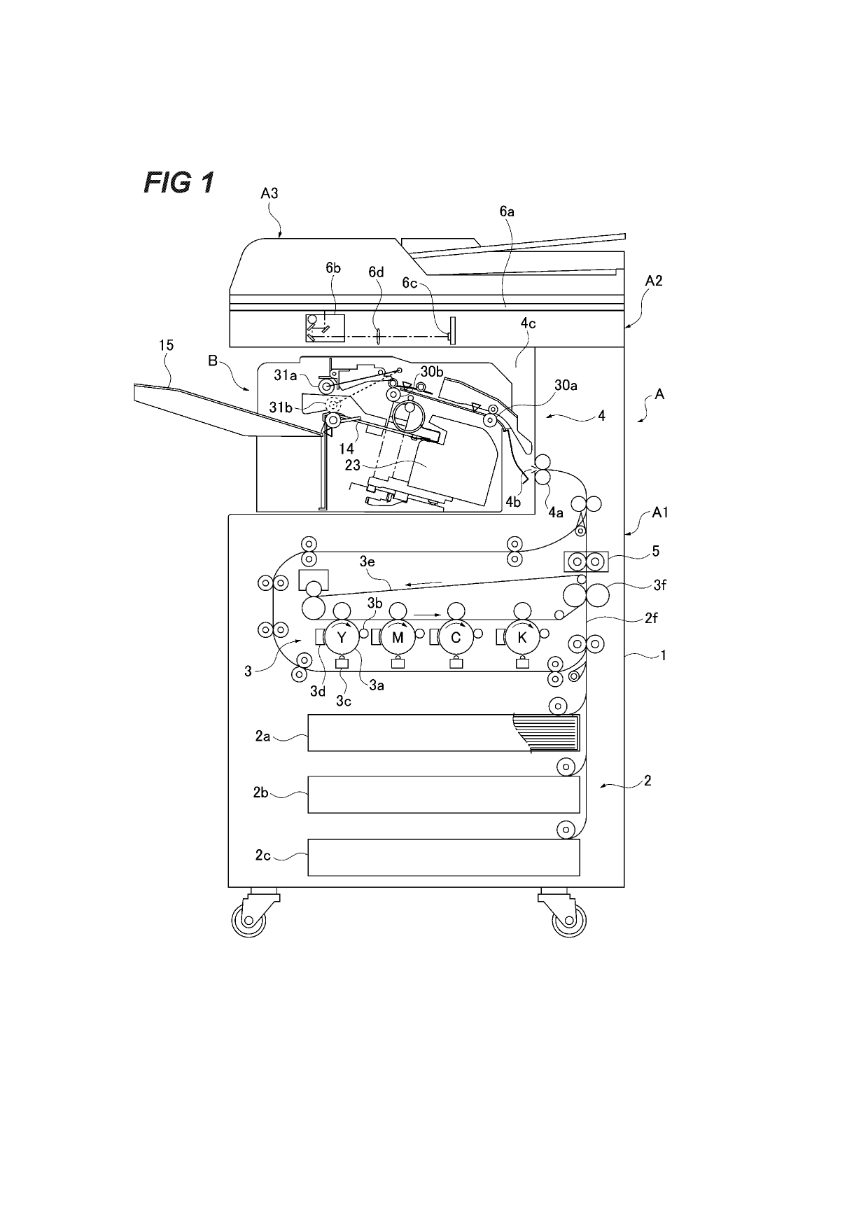

In the following, a sheet processing apparatus and an image forming system equipped with the sheet processing apparatus according to a preferred embodiments of the present invention will be described with reference to the drawings. FIG. 1 schematically shows the overall configuration of the image forming system with the sheet processing apparatus according to an embodiment of the present invention. As shown in the figure, the image forming system C is constituted by the image forming apparatus A and the sheet processing apparatus B attached to the image forming apparatus A.

### Image Forming Apparatus

The image forming apparatus A is constituted by the image forming unit A1, the scanner unit A2 and the feeder unit A3. The image forming unit A1 is provided with the feeding portion 2, the image forming portion 3 and the discharge portion 4 in the apparatus housing 1. The feeding portion 2 is constituted by the multiple cassette mechanisms 2a, 2b and 2c for accommodating sheets for image forming of the sizes different from each other.

The feeding portion 2 is constituted by the cassette mechanisms 2a, 2b and 2c that accommodate sheets for image formation having sizes different from each other. The feeding portion 2 sends a sheet of the size designated by the main body control portion to the sheet feeding path 2f. Each of the cassette mechanisms 2a, 2b and 2c are detachably attached to the feeding portion 2 and includes a separation mechanism that separates the inside sheets one by one and a feeding mechanism that sends out sheets. The conveying rollers that feed the sheets supplied from the cassette mechanisms 2a, 2b and 2c to the downstream side a registration roller pair that aligns the leading edge of each sheet are provided on the sheet feeding path 2f.

The image forming portion 3 adopts the electrophotographic system in the present embodiment and is provided with the rotating photosensitive drum 3a, the charging roller 3b, the exposure device 3c, the developing device 3d, and a cleaner (not shown) around the photosensitive drum 3a. The image forming portion 3 shown in FIG. 1 is a color printing mechanism and the image forming mechanism is provided for each color of yellow Y, magenta M, cyan C and black K.

When forming an image, the circumferential surface of the rotating photosensitive drum 3a is uniformly charged by the charging roller 3b, an electrostatic latent image is formed by irradiating the circumferential surface with a laser beam corresponding to an image signal with the exposure device 3c, and the latent image is developed into a toner image by the developing device 3d. Each color toner image that has been formed in this way is primarily transferred to the rotating intermediate transfer belt 3e to form a color image. The sheet is sent to the secondary transfer portion from the sheet feeding path 2f in synchronism with the timing of forming color image. In the secondary transfer portion, the toner image formed on the intermediate transfer belt 3d is transferred to the sheet by applying a transfer bias from the secondary transfer roller 3f. The sheet on which the toner image is transferred is heated and pressurized when passing through the fixing device 5 so that the toner image is fixed on the sheet. Thereafter, the sheet is discharged from the discharge port 4b by the discharge roller 4a and is conveyed to the sheet processing apparatus B that will be described later.

The scanner unit A2 is provided with the platen 6a on which an image document is placed, the carriage 6b that reciprocally moves along the platen 6a, the photoelectric conversion element 6c, the reduction optical system 6d that guides a light emitted from the carriage 6a and reflected from a document on the platen 6a to the photoelectric conversion element 6c. The photoelectric conversion element 6c photoelectrically converts an optical output from the reduction optical system 6d into image data and outputs the image data as an electric signal to the image forming portion 3. The scanner unit A2 can also read the document sheet sent from the feeder unit A3.

### Sheet Processing Apparatus

Next, the overall operation of the sheet processing apparatus B that processes the sheet sent from the image forming apparatus A will be described.

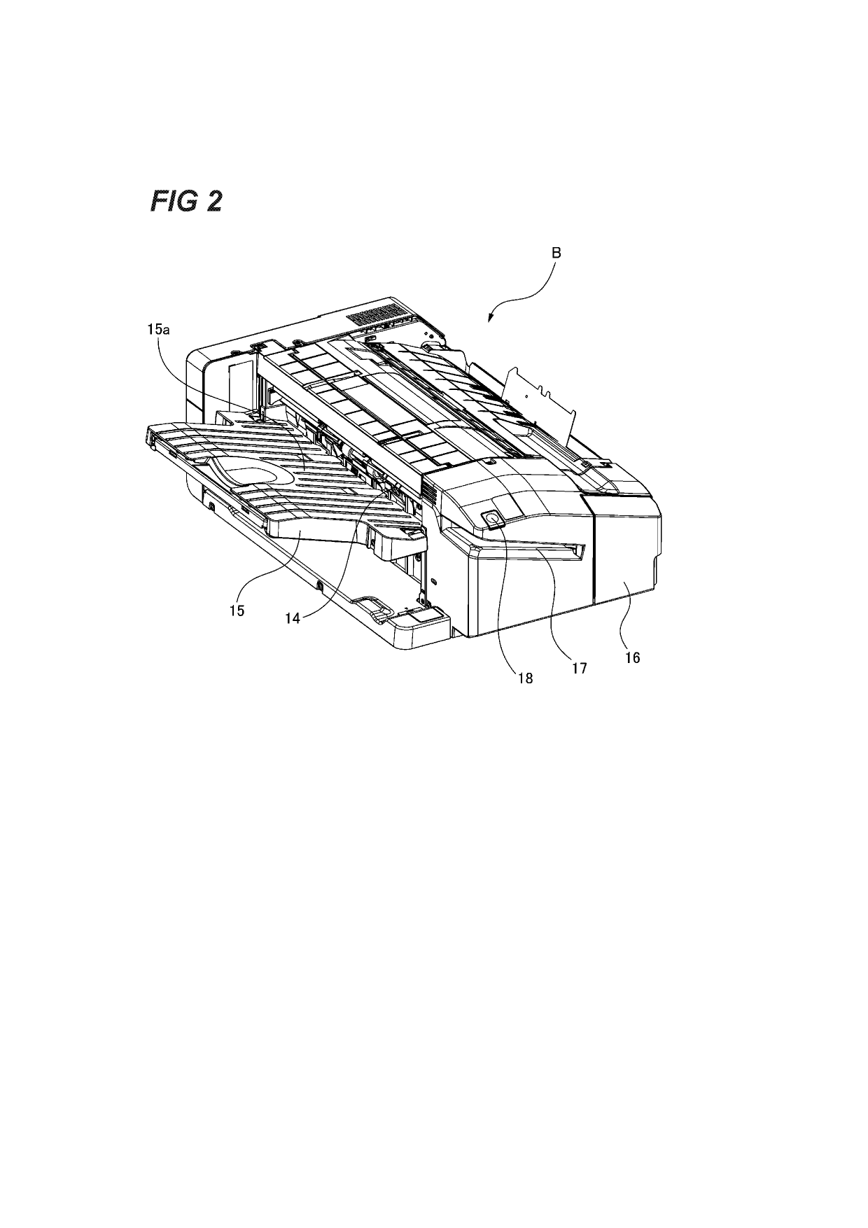

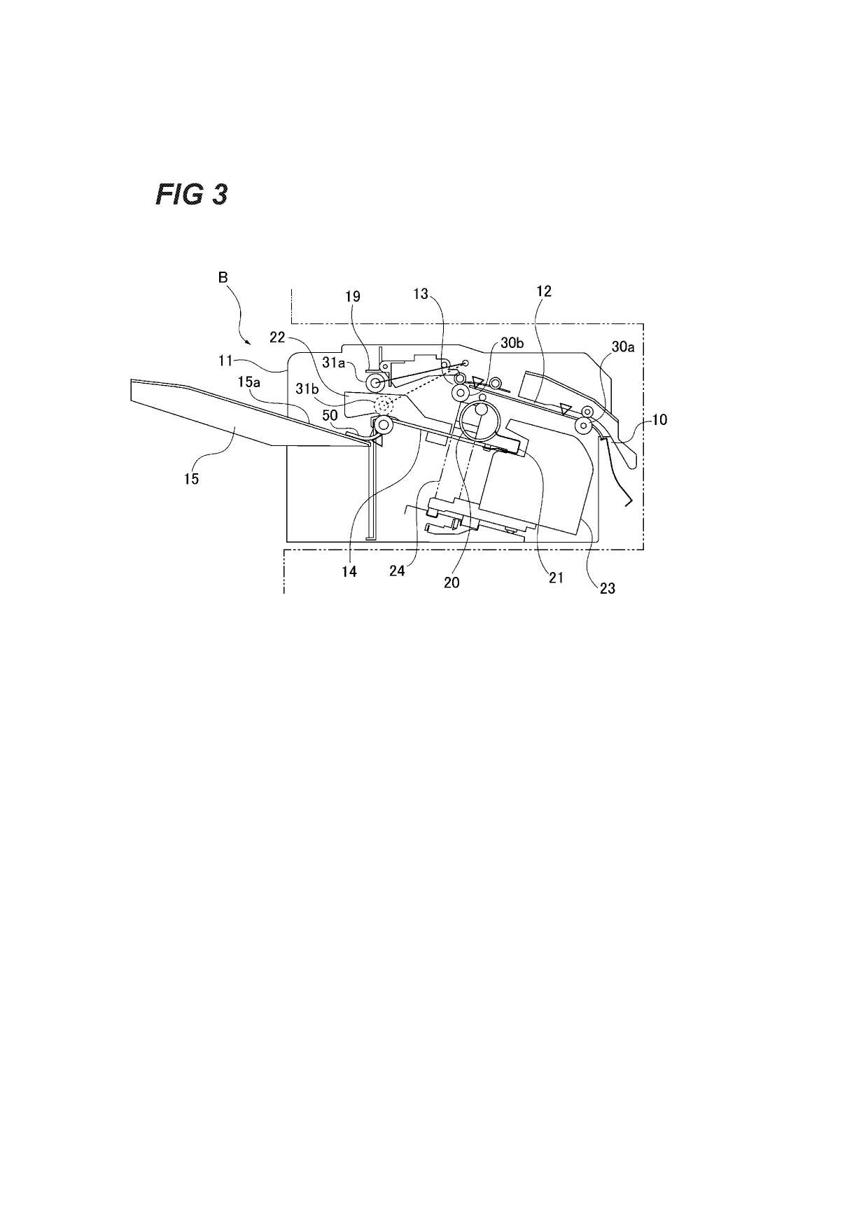

FIG. 2 is a diagram showing a perspective view of the sheet processing apparatus according to the present embodiment. FIG. 3 is an explanatory diagram showing the configuration of the sheet processing apparatus B. The sheet processing apparatus B is provided with the apparatus housing 11 in which the receiving port 10 is provided for introducing a sheet from the image forming apparatus A. The apparatus housing 11 is disposed in a position relative to the housing 1 of the image forming apparatus A such that the receiving port 10 communicates with the discharge port 4b of the image forming apparatus A.

The discharge portion 4 of the image forming apparatus A according to the present embodiment is formed in the space 4c (inside space) formed between the image forming unit A1 and the scanner unit A2 and the sheet processing apparatus B is disposed in the space 4c.

The sheet processing apparatus B is constituted by the apparatus frame 11, the sheet conveying path 12 disposed in the apparatus frame 11, the processing tray 14 disposed downstream of the outlet port 13 of the conveying path 12, the sheet stacking tray 15 disposed downstream of the processing tray 14. As shown in FIG. 2, at the front side of the apparatus frame 11, the opening 16 for attaching a cartridge of staples, the manual set portion 17, and the manual operation button 18.

Further, on the processing tray 14, the scraping paddle 19 that is made from a rubber plate and that scrapes the sheet to the rear end stopper 21, the knurl belt 20 made from rubber and on which circumferential surface knurling is performed are provided. Furthermore, on the processing tray 14, the sheet rear end stopper 21 that accumulates sheets in a bundle state and the aligning plate 22 are disposed. Moreover, provided on the processing tray 14, are the stapling unit 23 that performs a stapling process for a sheet bundle and the staple-free binding unit 24 that performs a staple-free binding process.

### Sheet Binding Mechanism

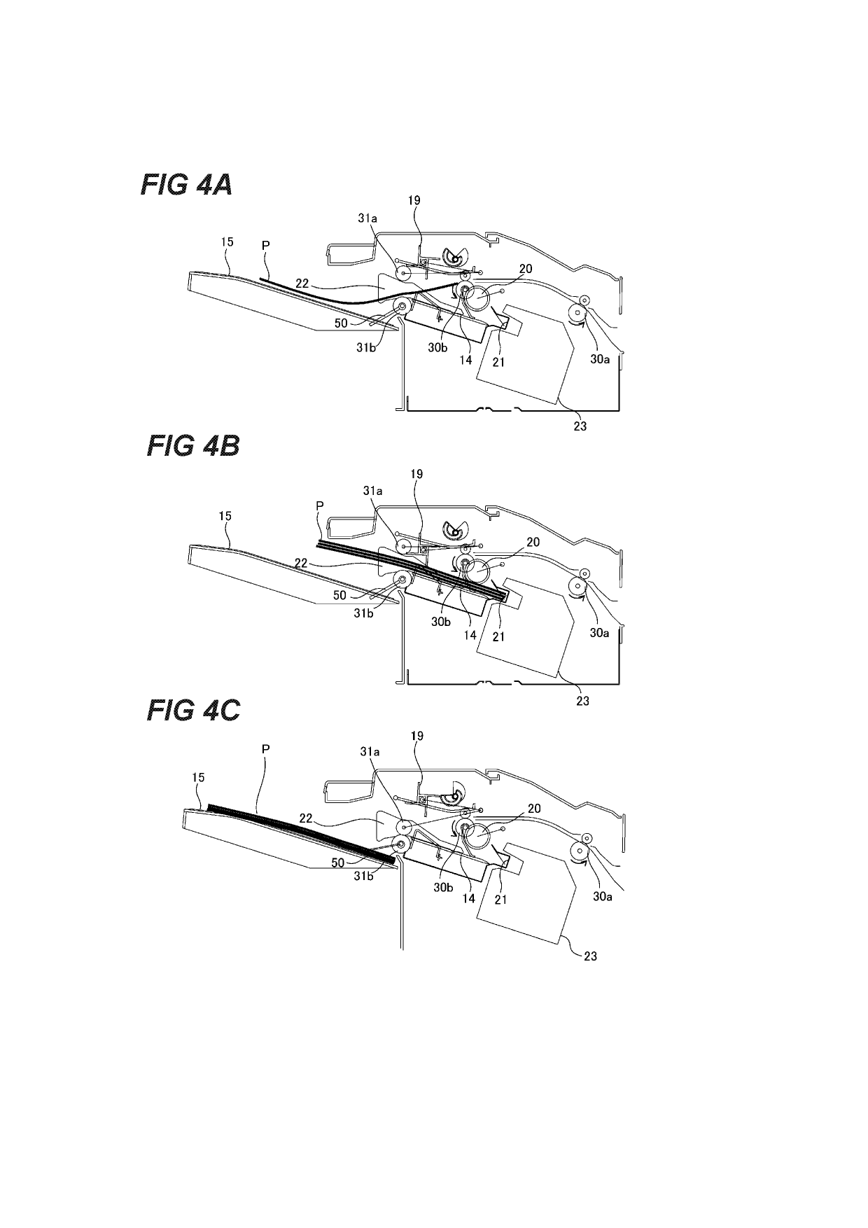

The sheet on which an image has been formed by the image forming apparatus A is sent to the receiving port 10 of the sheet processing apparatus B from the discharge port 4b of the image forming apparatus A. The sheet processing portion of the sheet processing apparatus B performs a predetermined sheet process for the sheet. In the sheet processing portion in the present embodiment, the sheet P sent from the receiving port 10 is conveyed by the conveying roller 30a (sheet conveying member) provided at the sheet conveying path 12 and is conveyed to the processing tray 14 by the conveying roller 30b (sheet conveying member) provided in the vicinity of the exit port 13 of the conveying path as shown in FIG. 4A.

The sheet P conveyed from the exit port 13 of the conveying path to the processing tray 14 is scraped off by the scraping paddle 19 that rotates in the anticlockwise direction shown in FIG. 4B. Further, the sheet P is conveyed by the knurl belt 20 that rotates in the anticlockwise direction such that the rear end of the sheet abuts against the sheet rear end stopper 21. Furthermore, both sides of the sheet in the width direction is aligned by the aligning plate 22 being slid in the sheet width direction.

After a predetermined number of sheets are conveyed to the processing tray 14 as described above, the stapling unit 23 (processing portion) is operated so as to perform a binding process for a sheet bundle on the processing tray 14. When the biding process is performed for the sheets, the upper side discharge roller 31a that is one of the pair of the distanced discharge rollers 31a and 31b is moved and the sheets on the processing tray 14 are nipped by the discharge rollers 31a and 31b. As shown in FIG. 4C, the driving force of the discharge motor is transmitted to the lower side discharge roller 31b. The sheets are discharged by the pair of the rotating discharge rollers 31a and 31b. As a result, the sheets are accommodated as stacked in the sheet stacking tray 15 (sheet stacking portion). The sheet stacking tray 15 is provided with a tray lifting mechanism by which the sheet staking tray 15 is lowered in response to the stacking amount of the sheets. Further, the sheet stacking tray 15 includes a stacking surface 15a, which is a region for stacking the sheets.

### Sheet Stacking Tray Lifting Mechanism

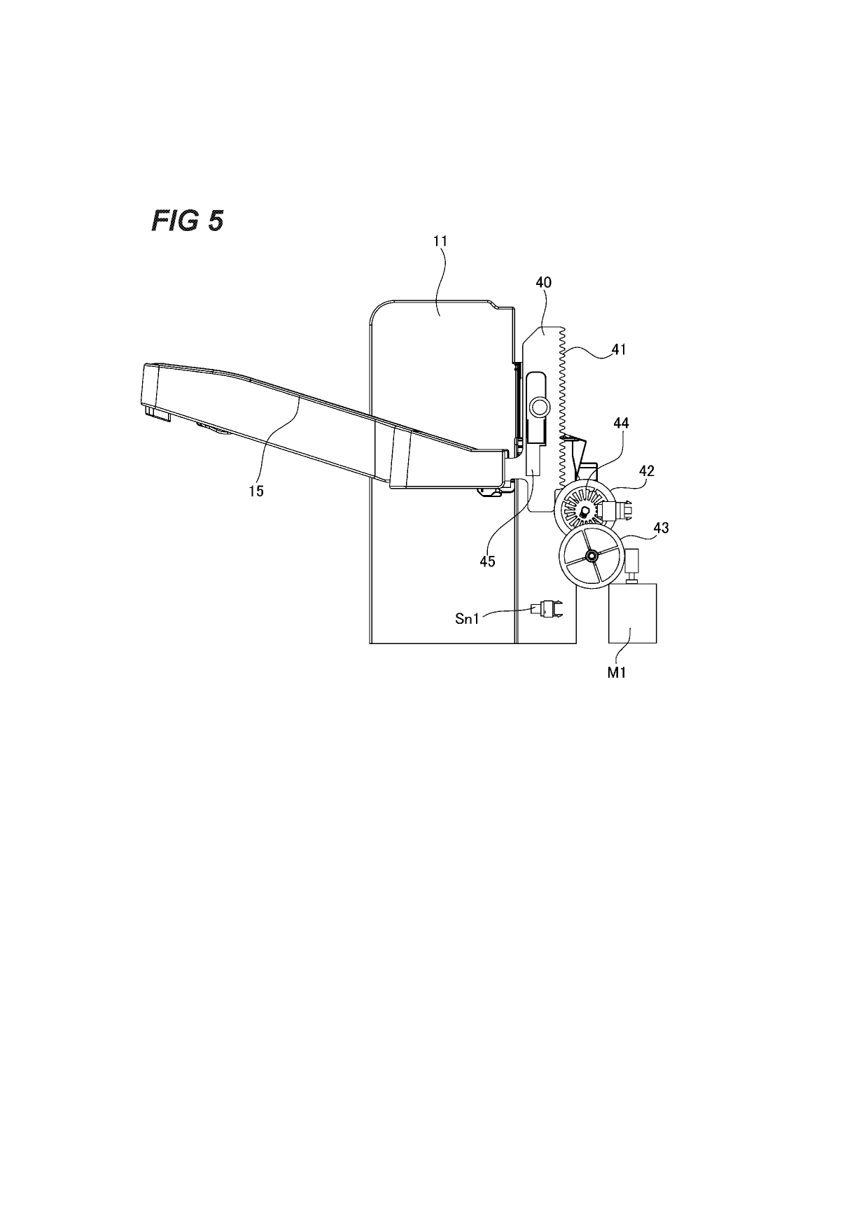

FIG. 5 is a diagram showing a lifting mechanism (lifting portion) that lifts up and down the sheet stacking tray 15. As shown in FIG. 5, the basal portion 40 of the sheet stacking tray 15 is attached to be slidable along a rail (not shown) formed on the apparatus housing 11 in the vertical direction. The rack portion 41 formed on the tray basal portion 40 meshes with the pinion gear 42 provided on the apparatus housing 11. The pinion gear 42 rotates by receiving a driving force from the tray lifting motor M1 via the transmission gear 43, causing the rack portion 41 to move upward and downward. As a result, the sheet stacking tray 15 is lifted up and down. The encoder 44 is attached to the pinion gear 42 and the encoder 44 rotates integrally with the pinion gear 42. By detecting the rotation amount of the encoder 44, the lifting amount of the sheet stacking tray 15 can be controlled.

In a predetermined position of the apparatus housing 11, the sheet stacking tray HP (Home Position) sensor Sn1 is provided. By the sensor Sn1 detecting the sensor flag 44 provided on the basal portion 40 of the tray, the sheet stacking tray 15 can be located in the home position.

As will be described later, the sheet stacking tray 15 is controlled as to be lifted up and down in accordance with the discharge of the sheets . Further, the sheet pressing paddle 50 is controlled to be rotated in accordance with the discharge of the sheets and the elevation of the sheet stacking tray 15.

### Sheet pressing paddle

The sheet pressing paddle 50 is a sheet pressing member that presses the upper surface of the sheets discharged and stacked on the sheet stacking tray 15 to prevent the sheets already stacked on the stacking tray from being pushed out by the subsequent sheets to be discharged onto the sheet stacking tray 15. The sheet pressing paddle 50 is rotatable coaxially with the lower side discharge roller 31b and is rotatable independently on the lower side discharge roller 31b.

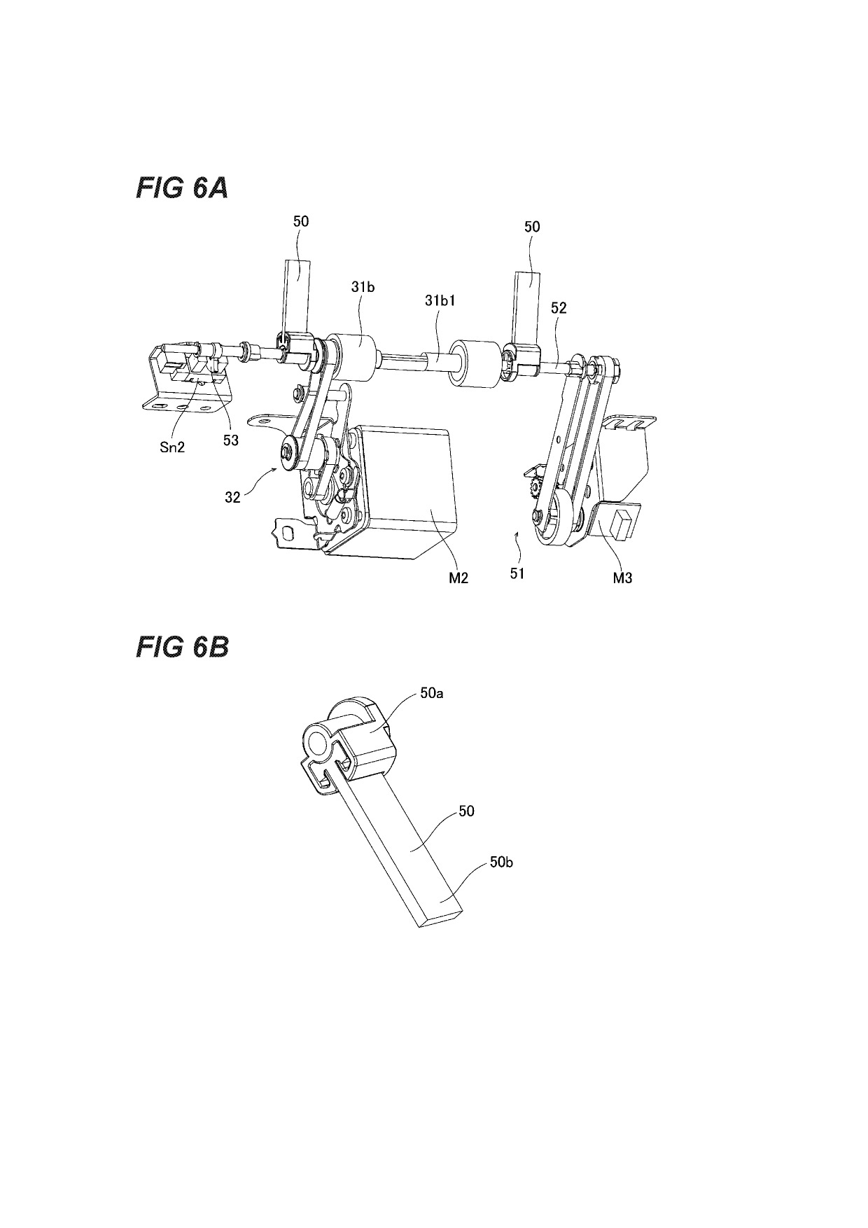

FIG. 6A is a diagram showing an extracted perspective view of the driving structure (rotating mechanism) of the lower side discharge roller 31b and the sheet pressing paddle 50.

The lower side discharge roller 31b is driven by the discharge motor M2 via the driving force transmission mechanism 32. The driving force transmission mechanism 32 is constituted by a pully and a belt in the example shown in the figure and transmits a rotation driving force of the driving shaft of the discharge motor M2 to the rotation shaft 31b1 of the lower side discharge roller 31b. The sheet pressing paddle 50 is driven by the sheet pressing paddle motor M3 (driving portion) via the driving force transmission mechanism 51. The driving force transmission mechanism 51 is constituted by a pully and a belt in the example shown in the figure and transmits a rotation driving force of the driving shaft of the sheet pressing paddle motor M3 to the rotation shaft 52 of the sheet pressing paddle 50.

The rotation shaft 52 of the sheet pressing paddle 50 can pass through the inside of the rotation shaft 31b1 of the lower side discharge roller 31b. The two sheet pressing paddles 50 at the both sides of the lower side discharge roller 31b in the rotational axis direction can be disposed on the single rotation shaft 52. The rotation shaft 31b1 of the lower side discharge roller 31b is rotatably supported by the rotation shaft 52 of the sheet pressing paddle 50 via the bearing, for example. With this configuration, the lower side discharge roller 31b and the sheet pressing paddle 50 can be driven by different motors respectively independently on each other. The driving force transmission mechanisms 32 and 51 can be constituted by other driving force transmission members such as plurality of gears other than the configuration using a pully and a belt.

As shown in FIG. 6B, the sheet pressing paddle 50 has the securing portion 50a that is fixed to the rotation shaft 52 and the plate-like paddle portion 50b (abutting portion) that is provided on the securing portion 50a. The paddle portion 50b has elasticity. The paddle portion 50b extends from the securing portion 50a fixed to the rotation shaft 52 to the direction perpendicular to the rotation shaft 52. The paddle portion 50b is formed by elastic member such as rubber (for example, ethylene propylene rubber (EPDM) whose hardness is 30 ± 5 HS (A) (old Japanese Industrial Standards (JIS) K6301, spring type A)). The sheet pressing paddle 50 configured in this way rotates by the rotation of the rotation shaft 52 and presses the rear end of the sheet by being elastically deformed when the paddle portion 50b abuts against the sheets on the sheet stacking tray 15.

The sensor flag 53 is provided on the rotation shaft 52 of the sheet pressing paddle 50 such that the sensor flag 53 rotates integrally with the rotation shaft 52. Further, the paddle HP sensor Sn2 that can detect the sensor flag 53 is provided on the apparatus housing 11. The position where the paddle HP sensor Sn2 detects the sensor flag 53 is recognized as a home position of the sheet pressing paddle 50.

### Control Portion

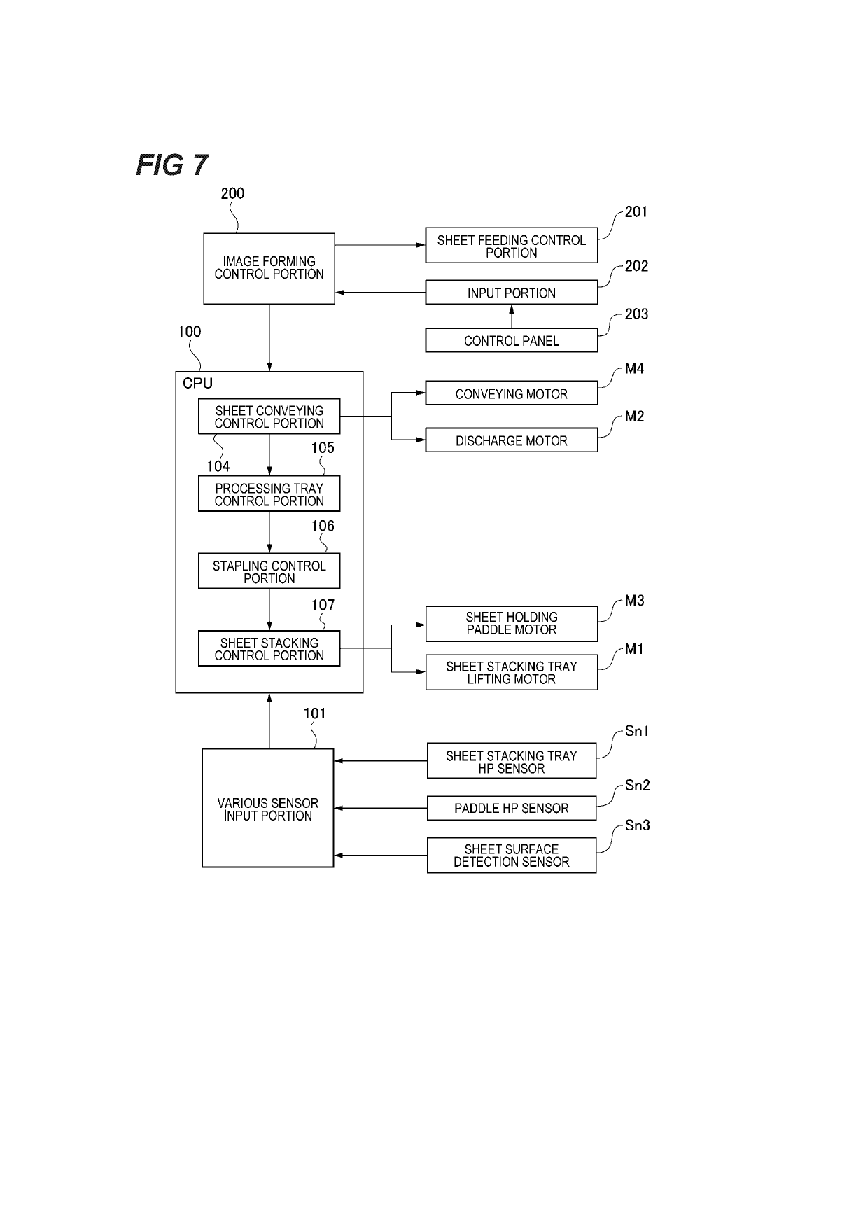

Next, the control structure of the image forming system will be described referring to the block diagram of FIG. 7.

The image forming system according to the present embodiment includes the image forming control portion 200 of the image forming apparatus A and the sheet processing apparatus control portion (CPU which can also be referred to as MPU, which indicates a device of not only a portion that performs a calculation but also a calculation function of CPU being integrated on a chip ) of the sheet processing apparatus B.

The image forming control portion 200 is provided with the sheet feeding control portion 201 and the input portion 202. From the control panel 203 provided on the input portion 202, "print mode" and "sheet processing mode" is set.

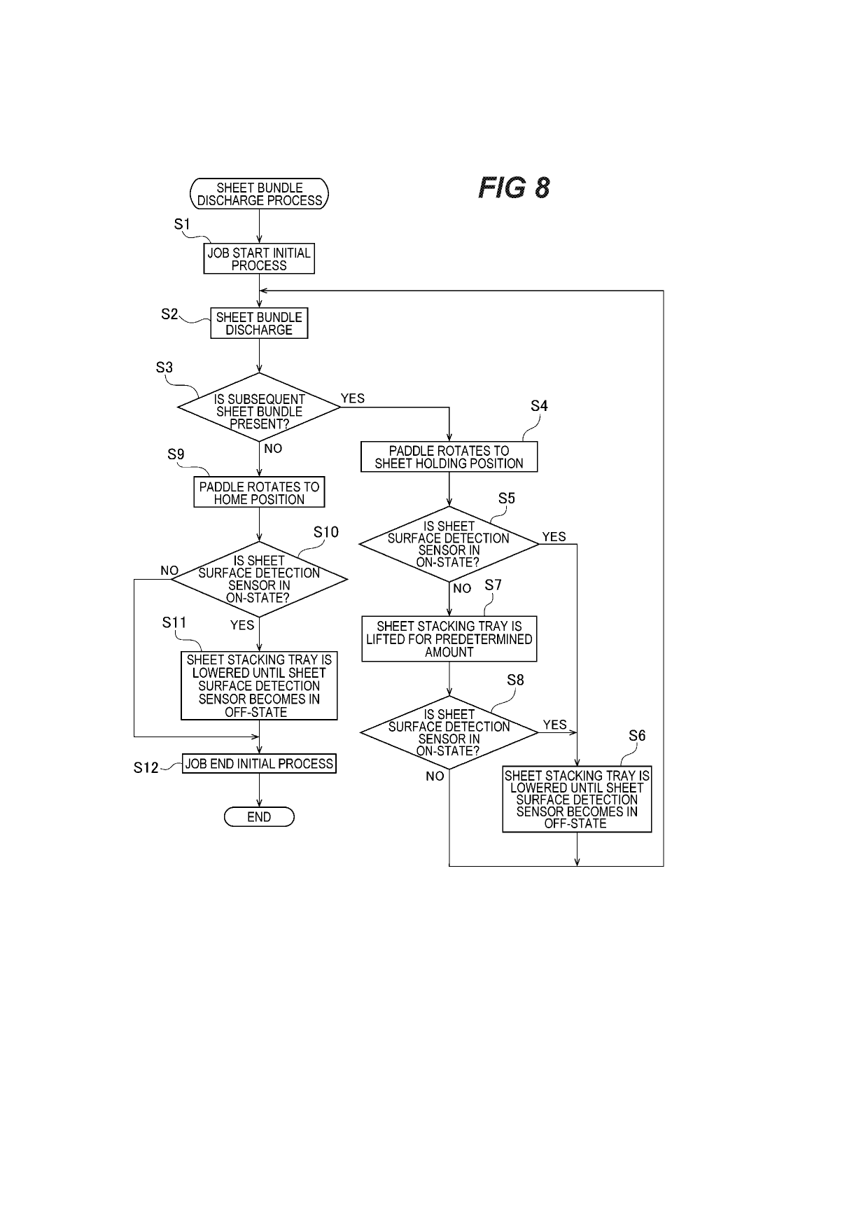

The sheet processing apparatus control portion 100 operates the sheet processing apparatus B according to sheet processing mode. The sheet processing apparatus control portion 100 is provided with a ROM that stores an operation program indicated by the flowchart in FIG. 8 and a RAM that stores control data. The signals from various sensors such as the sheet stacking tray HP sensor Sn1 that detects a home position of the sheet stacking tray 15, the paddle HP sensor Sn2 that detects a home position of the sheet pressing paddle 50, and the sheet surface detection sensor Sn3 that detects the upper surface of the sheets stacked on the sheet stacking tray 15 are input to the sheet processing apparatus control portion 100 via the various sensor input portion 101. The sheet surface detection sensor Sn3 is provided in a predetermined position of the moving area of the sheet stacking tray 15 and detects the sheet stacking surface of the sheet stacking tray 15 and the surface of the uppermost sheet of the stacked sheets in a case where the sheets are stacked on the sheet stacking tray 15. The sheet surface detection sensor Sn3 becomes in on-state when the sheet surface detection sensor Sn3 detects sheets stacked on the sheet stacking tray 15 and the sheet surface detection sensor Sn3 becomes in off-state when the sheet surface detection sensor Sn3 does not detect sheets stacked on the sheet stacking tray 15.

The sheet processing apparatus control portion 100 has the sheet conveying control portion 104 that controls the discharge motor M2 that provides a driving force to the discharge roller 31b, and the conveying motor M4 that provides a driving force to the conveying rollers 30a, 30b.

Further, the sheet processing apparatus control portion 100 has the processing tray control portion 105 that controls the driving of an aligning motor that moves the aligning plate 22 that performs a sheet accumulation operation on the processing tray 14 and a motor that rotates the scraping paddle 19 and the knurl belt 20. Furthermore, the sheet processing apparatus control portion 100 has the stapling control portion 106 that performs a stapling process for a sheet bundle on the processing tray 14.

Moreover, the sheet processing apparatus control portion 100 also has the sheet stacking control portion 107 that controls the sheet stacking tray elevation motor M1 that lifts the sheet stacking tray 15 up and down and the sheet pressing paddle motor M3 that operates the sheet pressing paddle 50.

The sheet processes such as an image forming process and the sheet discharge and stacking process indicated by the flowchart of FIG. 8 are performed under control of the above control portions.

### Sheet Discharge and Stacking Process Control

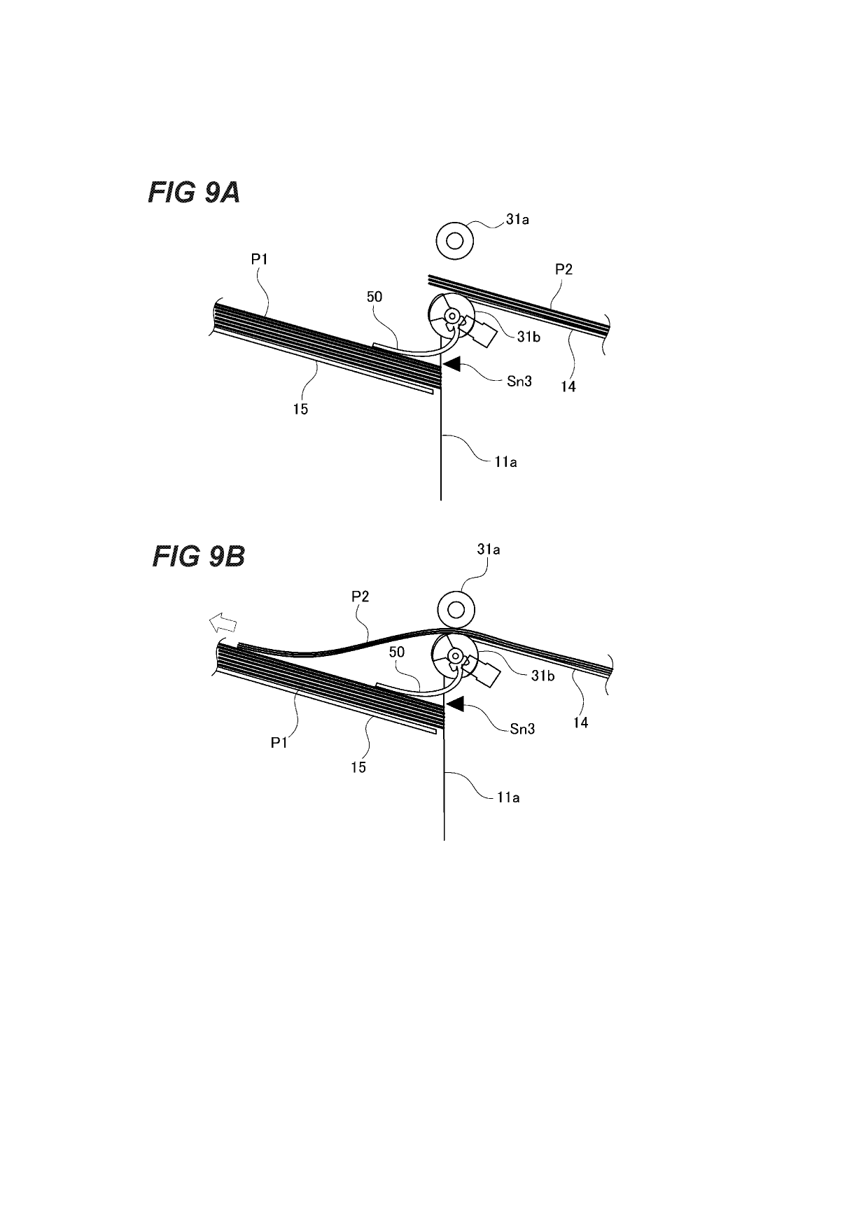

The sheet processing apparatus B according to the present embodiment enables the sheet pressing paddle 50 to operate properly by controlling the driving of the elevation operation of the sheet stacking tray 15 and the rotation operation of the sheet pressing paddle 50 as shown in the flowchart of FIG. 8 when sheets stapled by the stapling unit 23 are discharged onto the sheet stacking tray 15. Next, the driving control therefor will be described referring to the flowchart of FIG. 8 and FIGS. 9A, 9B, 10A, 10B, 11, 12A, 12B, 12C, and 13 in which operations are described.

In the present embodiment, a single sheet discharge mode and a bundle sheet discharge mode are provided. In the single sheet discharge mode, sheets are discharged onto the sheet stacking tray 15 one by one without performing a binding process. In the bundle sheet discharge mode, a predetermined number of sheets are conveyed to the processing tray 14, aligned there, stapled by the stapling unit 23, and discharged on to the sheet stacking tray 15 as a sheet bundle. Next, the elevation control of the sheet stacking tray 15 and the rotation control of the sheet pressing paddle 50 in a case where the sheets are discharged to the sheet stacking tray 15 by exemplifying the bundle sheet discharge mode. However, principally the same operation can be made in a case of the single sheet discharge mode. In the following, a case is described in which multiple sheet bundles, each formed by stacking a predetermined number of predetermined sheets, are continuously discharged in the bundle sheet discharge mode. It should be noted that the predetermined sheets mentioned above are A4-sized sheets with a basis weight of 80 g/m², and the predetermined number of sheets is 10. However, other sizes, basis weights, and sheet counts may also be applicable.

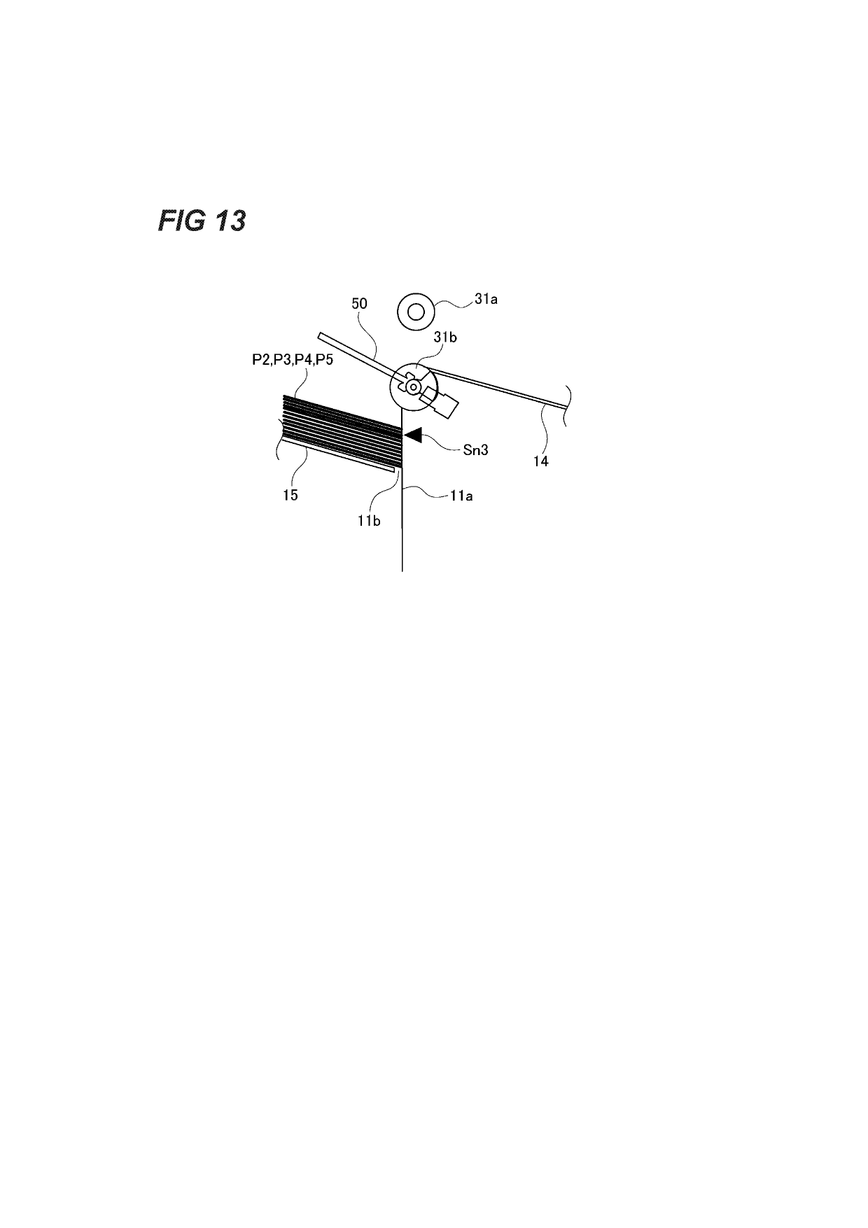

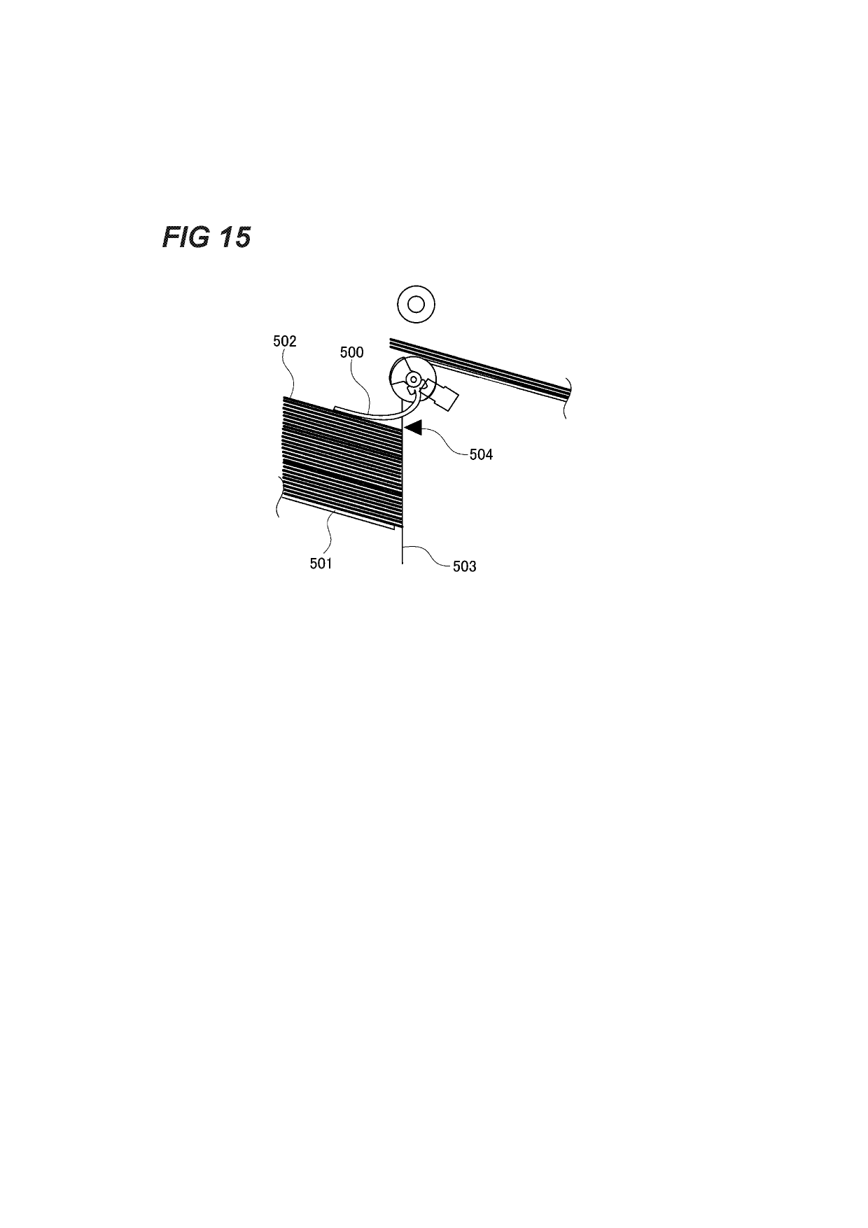

When a job of bundle discharge mode is received, a discharge initial process is performed before discharging the sheets (step S1). This step can be performed when the power of apparatus is turned on. In this discharge initial process, the sheet stacking tray 15 is lifted down and moved to the home position by being detected by the sheet stacking tray HP sensor Sn1. Further, the encoder 44 is reset to register the position of the sheet stacking tray 15 when the sheet stacking tray 15 is in the home position. Thereafter, the sheet stacking tray 15 is lifted up to the position where the sheet surface detection sensor Sn3 becomes in on-state. Then, the sheet stacking tray 15 is lifted down to the position where the sheet surface detection sensor Sn3 becomes in off-state and there the sheet stacking tray 15 is stopped. As a result, the sheet stacking surface of the sheet stacking tray 15 is moved to the sheet receiving position that is slightly lower than the position opposed to the sheet surface detection sensor Sn3. Further, the sheet pressing paddle 50 (indicated in FIG. 13) is moved from the home position to the sheet pressing position (indicated in FIGS. 3 and 15) and is stopped there. It should be noted that the above-mentioned sheet receiving position is equivalent to a position where the height of the stacking surface 15a or the uppermost sheet of a sheet bundle stacked on the stacking surface 15a falls within a predetermined range. Alternatively, a position obtained by lifting or lowering the sheet stacking tray 15 by a predetermined distance from the position where the sheet surface detection sensor Sn3 turns on may be used as the receiving position.

A predetermined number of sheets are conveyed to the processing tray 14 where the sheets are aligned and a stapling process is performed to the sheets by the stapling unit 23. The stapled sheet bundle is discharged to the sheet stacking tray 15 in the above state by the pair of the discharge rollers 31a and 31b (step S2). When the discharged sheet bundle is not the last one of the continuously discharged sheet bundles, namely, when the sheet bundle P2 is subsequently discharged to the sheet stacking tray 15 after the sheet bundle P1 has been discharged as shown in FIG. 9A ("YES" in step S3), the sheet pressing paddle 50 is rotated to the position where the paddle portion 50b presses the upper surface of the sheets on the sheet stacking tray 15 (step S4). As a result, the paddle portion 50b is elastically deformed so that the paddle portion 50b presses the sheet bundle P1 on the sheet stacking tray 15 from above (see FIG. 9A). Further, one end portion of the sheet bundle P1 abuts against the vertical surface 11a (abutting surface) of the apparatus housing 11 to restrict the movement to the direction opposite to the sheet discharging direction.

Next, whether a sheet bundle is removed from the sheet stacking tray 15 or not is judged. This judgement is performed based on whether the sheet surface detection sensor Sn3 is in on-state or not after the sheet bundle has been discharged in the present embodiment (step S5).

When the sheet surface detection sensor Sn3 becomes in on-state as a result of the preceding sheet bundle P1 being discharged on the sheet stacking tray 15 ("YES" in step S5), the sheets are discharged in the normal discharge mode (first discharge mode) judging that the sheet bundle having been discharged on the sheet stacking tray 15 remains stacked as it is. In this normal discharge mode, in order to receive the subsequent sheet bundle P2, the sheet stacking tray 15 is lowered until the sheet surface detection sensor Sn3 becomes in off-state, namely, until the upper surface of the discharged sheet bundle P1 becomes lower than the sheet surface detection sensor Sn3 (step S6).

Next, the sequence returns to step S2 where the subsequent sheet bundle P2 is discharged on the sheet stacking tray 15 (see FIG. 9B). The subsequent sheet bundle P2 is discharged on the preceding sheet bundle P1 that has already been discharged on the sheet stacking tray 15. However, the preceding sheet bundle P1 is held by the sheet pressing paddle 50 so that the preceding sheet bundle P1 is not pushed out from the sheet stacking tray 15 by the discharged sheet bundle P2.

By performing the above described discharge process to the sheet bundles P1, P2, … that are continuously discharged onto the sheet stacking tray 15, the sheet bundles are subsequently discharged and stacked on the sheet stacking tray 15.

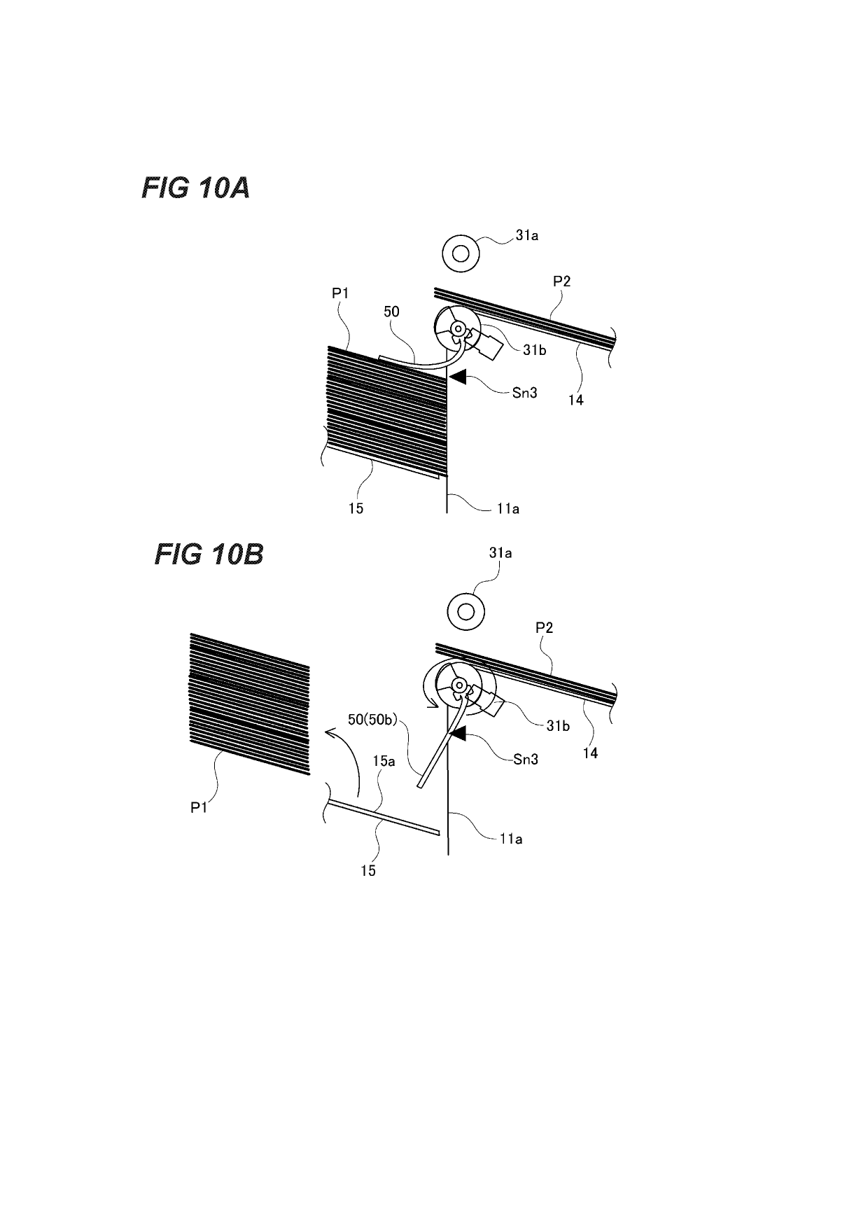

Next, the case will be described where the sheet bundle P1 having already been stacked on the sheet stacking tray 15 is removed as shown in FIG. 10B midway during sheet bundles are continuously discharged on the sheet stacking tray 15 as shown in FIG. 10A. In the present embodiment, when the number of sheets in the removed sheet bundle P1 exceeds 200, the sheet pressing paddle 50 (specifically, the paddle portion 50b) is positioned away from the stacking surface 15a of the sheet stacking tray 15 in the pressing position, and the tip of the sheet pressing paddle 50 is oriented downward, as shown in FIG. 10B. When the sheet bundle P1 having already been stacked on the sheet stacking tray 15 is removed from the sheet stacking tray 15, the sheet surface detection sensor Sn3 becomes in off-state due to the absence of sheet bundle ("NO" in step S5). Namely, when the sheet surface detection sensor Sn3 becomes in off-state although the sheet bundle P1 has been discharged, it is judged that the sheet bundle is removed from the sheet stacking tray 15. When the sheet bundle P2 to be subsequently discharged is present, it is discharged in a discharge-after-removal mode (second discharge mode).

In the case of the discharge-after-removal mode, the sequence proceeds to step S7 where the sheet stacking tray 15 is lifted up for a predetermined amount (step S7). The predetermined amount for which the sheet stacking tray 15 is lifted up is a length with which the sheet pressing paddle 50 can be rotated with the sheet stacking tray 15 having been lifted up for the length.

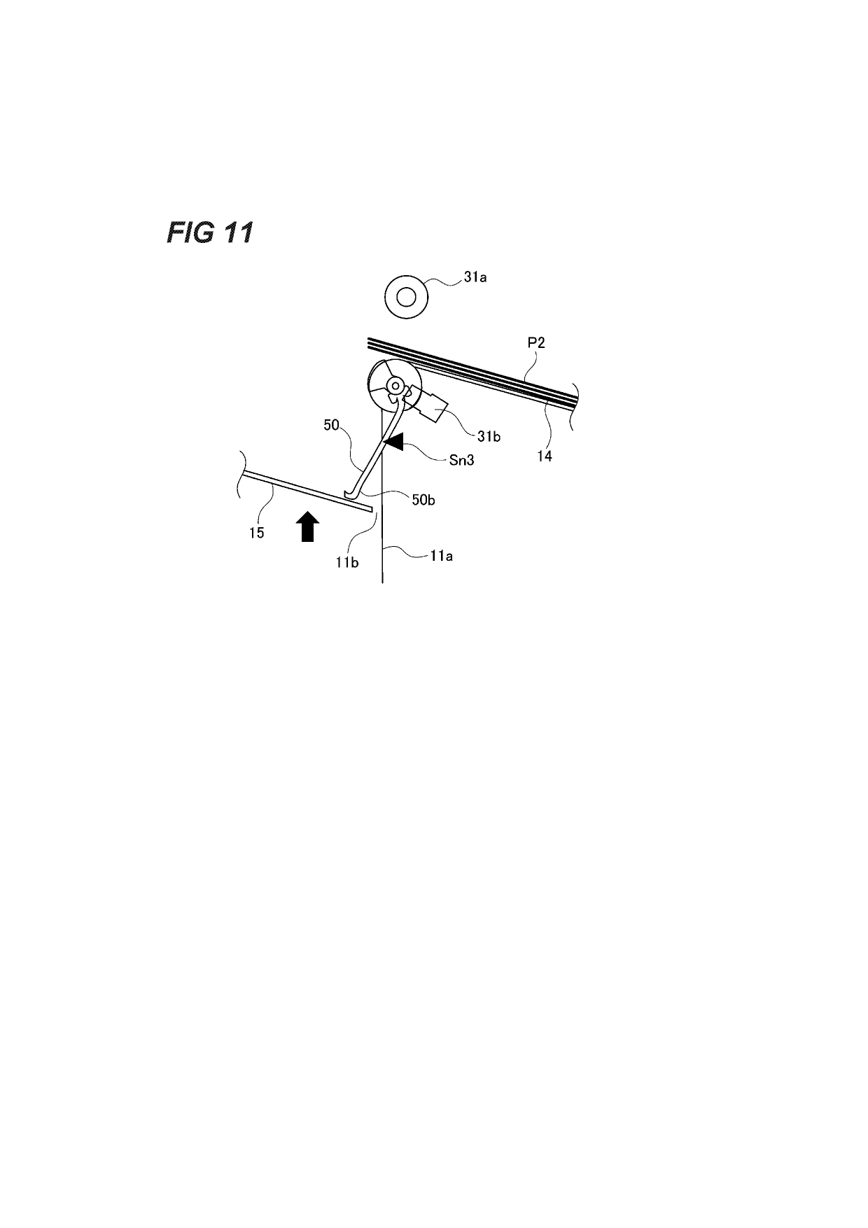

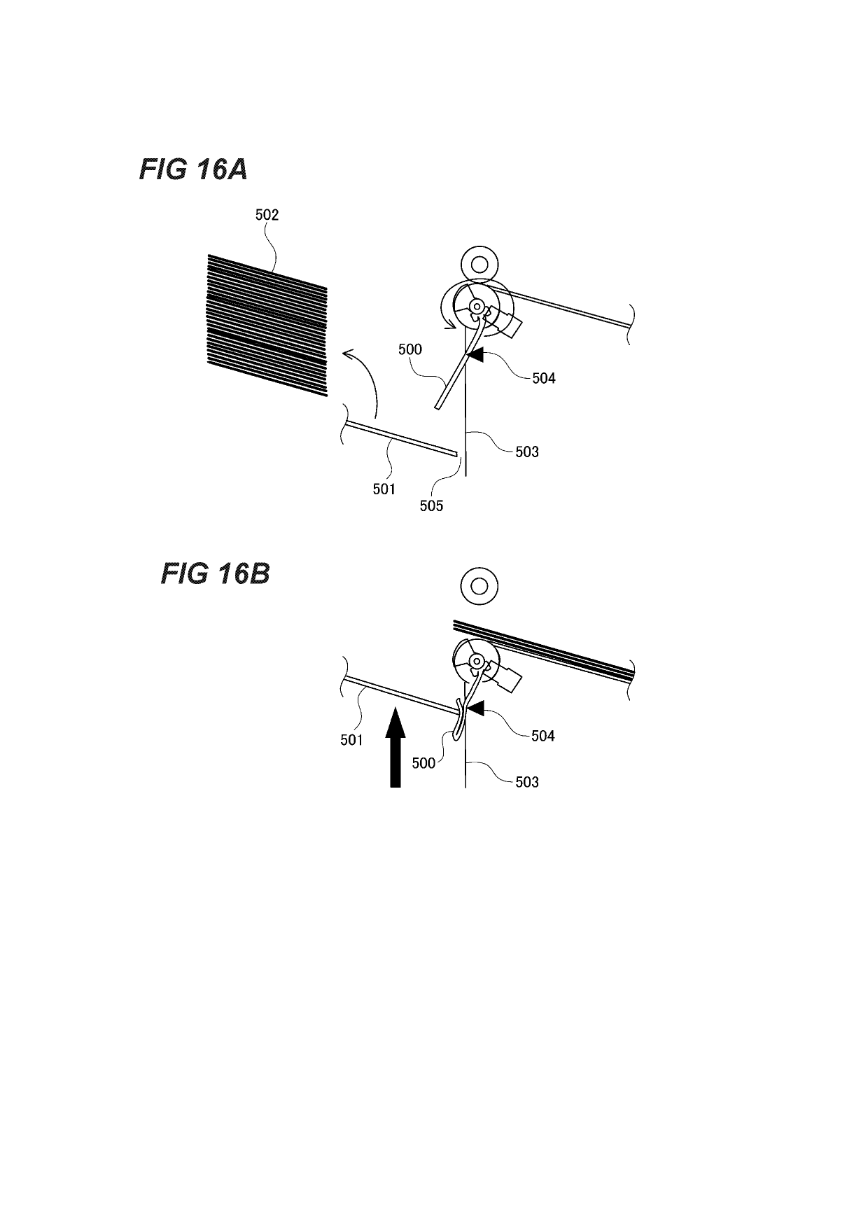

The predetermined amount for which the tray is lifted up after the sheet removal will be specifically described. As shown in FIG. 11, the gap 11b is formed between the end portion of the sheet stacking tray 15 and the vertical surface 11a of the apparatus housing 11 for the sheet stacking tray 15 to be smoothly lifted up and down along the vertical surface 11a. The gap 11b has such a length that even if the sheet stacking tray 15 is a little deflected by a large amount of sheets being stacked on the sheet stacking tray 15, the sheet stacking tray 15 does not abut against the vertical surface 11a. In the present embodiment, the gap 11b is formed to have a length of about 5 mm. Therefore, in the state where the sheet pressing paddle 50 is in the sheet pressing position and the tip of the paddle portion 50b abuts against the sheet stacking tray 15, when the sheet stacking tray 15 is lifted all at once until the sheet surface detection sensor Sn3 becomes in on-state, the paddle portion 50b that can be elastically deformed is deflected and bent, so that the paddle portion 50b may enter the gap 11b (see FIG. 16B). Further, when the paddle portion 50b enters the gap 11b, the sheet pressing paddle 50 cannot be rotated even if the sheet pressing paddle motor M3 is driven.

As shown in FIG. 11, the above-mentioned predetermined amount is such an elevation amount of the sheet stacking tray 15 that when the sheet stacking tray 15 is lifted up for the elevation amount from the state where the tip of the paddle portion 50b abuts against the sheet stacking tray 15, the paddle portion 50b that can be elastically deformed is not so deformed that the paddle portion 50b enters the gap 11b or the sheet pressing paddle 50 can be rotated when the sheet pressing paddle motor M3 is driven even if the deformed paddle portion 50b barely enters the gap 11b. This predetermined amount depends on the material of the paddle portion 50b, the shape of the paddle such as length and thickness, and the length of the gap 11b. The predetermined amount can be obtained as follows. From the state where the tip of the sheet pressing paddle 50 abuts against the sheet stacking tray 15, the sheet stacking tray 15 is lifted up for a minute amount and it is judged that the sheet pressing paddle 50 can be rotated or not. By repeating this step until the sheet pressing paddle 50 is bent and enters the gap 11b to be unable to rotate, the maximum rotatable elevation amount is obtained and determined as the predetermined amount.

The paddle portion 50b of the sheet pressing paddle 50 according to the present embodiment is an elastically deformable rubber member and has a length of 31 [mm], a width of 9.5 [mm], and a thickness of 2.5 [mm]. The gap 11b between the sheet stacking tray 15 and the vertical surface 11a has a length of 5 [mm]. Using this sheet pressing paddle 50, the predetermined amount was attempted to be obtained in the way described above. The sheet pressing paddle 50 was able to be rotated until the sheet stacking tray 15 is lifted up for 6 [mm] from the position where the tip of the paddle portion 50b abuts against the sheet stacking tray 15. Therefore, the predetermined amount in the apparatus according to the present embodiment is set to 6 [mm]. The elevation of the tray for this predetermined amount is controlled by counting a number of pulses of the rotating encoder 44.

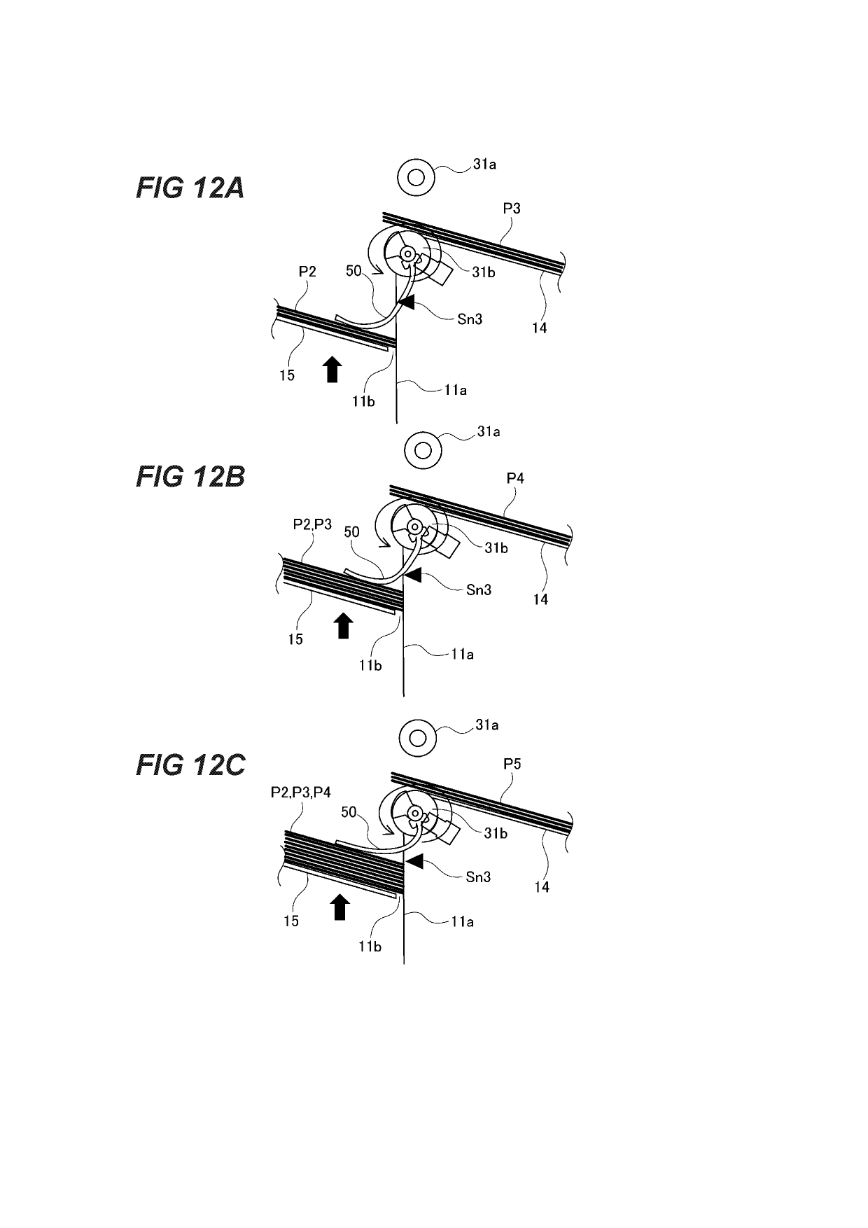

When the sheets having already been stacked on the sheet stacking tray 15 are removed midway during the discharge of the subsequent sheets and the sheet surface detection sensor Sn3 becomes in off-state as described above, the sheet stacking tray 15 is lifted up for the predetermined amount as shown in FIG. 12A. Then, it is judged that the sheet surface detection sensor Sn3 becomes in on-state or not (step S8). When the sheet surface detection sensor Sn3 remains in off-state even if the sheet stacking tray 15 is lifted up as shown in the above description ("NO" in step S8), the sequence returns to step S2 where the subsequent sheet bundle P2 is discharged and the sheet pressing paddle 50 is rotated to the sheet pressing position. On the other hand, when the sheet surface detection sensor Sn3 becomes in on-state as a result of lifting the sheet stacking tray 15 being lifted up for the predetermined amount ("YES" in step S8), the sequence proceeds to step S6 where the sheet stacking tray 15 is lowered until the sheet surface detection sensor Sn3 becomes in off-state. Then, the sequence proceeds to step S2 where the subsequent sheet bundle P2 is discharged.

As described above, when the sheet surface detection sensor Sn3 remains in off-state even if the sheet bundle is discharged, the discharge-after-removal mode is continued in which the discharge process is performed by lifting up the sheet stacking tray 15 for the predetermined amount, rotating the sheet pressing paddle 50 to the sheet pressing position, and pressing the upper surfaces of the sequentially discharged sheet bundles P3 and P4 as shown in FIGS. 12B and 12C.

As shown in the flowchart of FIG. 8, the lifting operation of the sheet stacking tray 15 by a predetermined amount is executed after the rotation of the sheet pressing paddle 50 (steps S4 → S5 → S7).

For subsequent sheet bundles, after the sheet bundle is discharged (step S2), the sheet pressing paddle 50 is rotated (step S4). Then, if the sheet surface detection sensor Sn3 is in an off-state (step S5), the sheet stacking tray 15 is lifted by a predetermined amount (step S7).

This sequence—namely, rotating the sheet pressing paddle 50 followed by lifting the sheet stacking tray 15 by a predetermined amount—is repeatedly performed until the sheet surface detection sensor Sn3 turns on-state.

In other words, after the previous sheet bundle P1 has been removed, the stack tray is repeatedly lifted by a predetermined amount in accordance with a command to rotate the sheet pressing paddle 50, in lifting the stack tray15 in a manner intended to maintain the height of the uppermost sheet of the sheet bundle on the stacking surface within a predetermined range.

As a result, even if the lifted sheet stacking tray 15 comes into contact with the downward-oriented paddle portion 50b of the sheet pressing paddle 50, the paddle rotates before the next lifting operation of the sheet stacking tray 15. Therefore, the angle at which the tip of the paddle portion 50b contacts the sheet stacking tray 15 during the subsequent lifting operation differs (see FIGS. 11 and 12A).

Accordingly, it is possible to prevent the paddle portion 50b of the sheet pressing paddle 50 from entering the gap 11b and becoming unable to rotate.

In other words, after the sheet stacking tray 15 is lifted by a predetermined amount once, the next lifting operation is executed only after the discharge of the next sheet bundle and the rotation of the sheet pressing paddle 50, and only if the sheet surface detection sensor Sn3 remains in the off-state.

Although this operation is conditional upon the off-state of the sheet surface detection sensor Sn3, it is equivalent to repeatedly lifting the sheet stacking tray 15 by a predetermined amount in accordance with a command to rotate the sheet pressing paddle 50.

When the sheet surface detection sensor Sn3 becomes in on-state after the discharged sheets are stacked on the sheet stacking tray 15 ("YES" in step S5), the sequence returns to the normal discharge mode in which the sheet stacking tray 15 is lowered until the sheet surface detection sensor Sn3 becomes in off-state and the subsequent sheets are discharged.

The sheet bundles are discharged in the way described above and after the last sheet bundle is discharged ("NO" in step S3), the sheet pressing paddle 50 is returned to the home position (FIG. 13, step S9). Then, the sheet stacking tray 15 is lowered until the sheet surface detection sensor Sn3 becomes in off-state (steps S10, S11). After that, the discharge end initial process is performed (step S12).

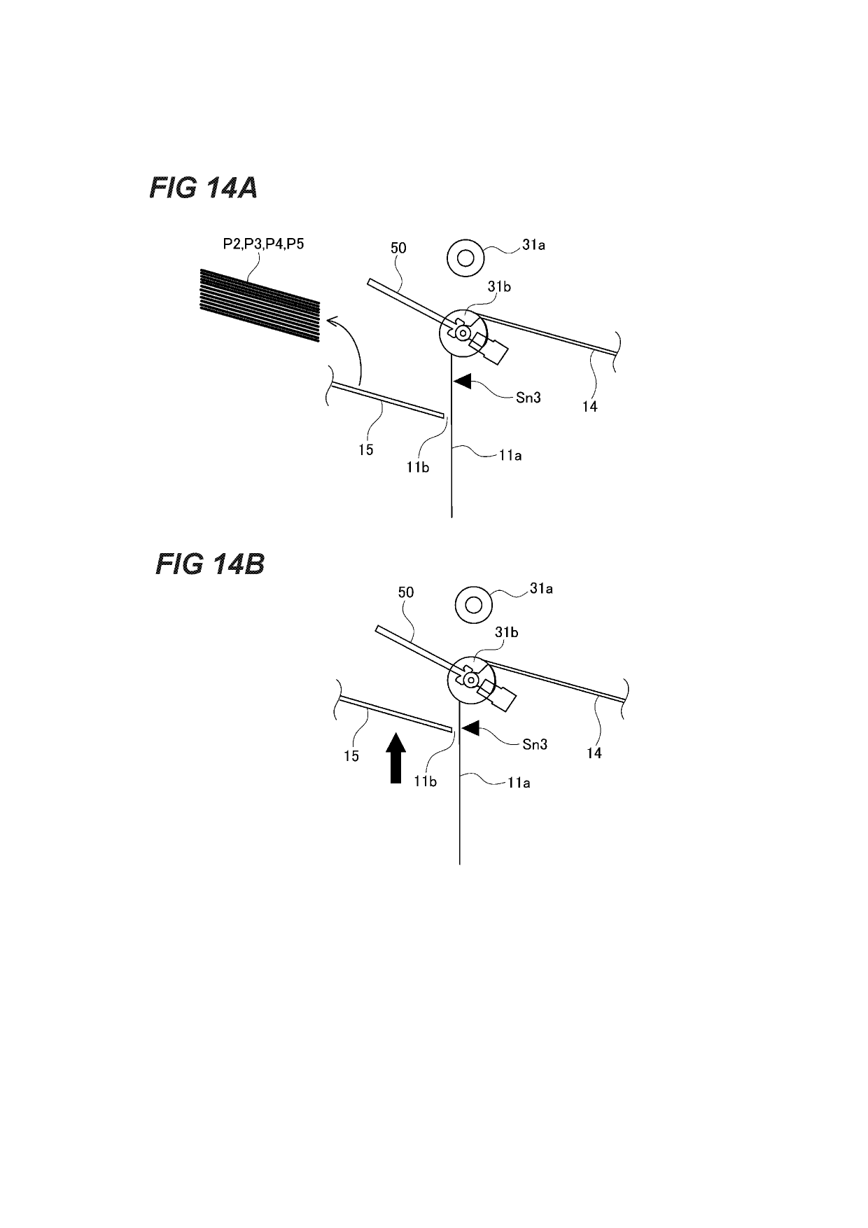

In the discharge end initial process, the sheet stacking tray 15 is lifted up until the sheet surface detection sensor Sn3 becomes in on-state and is stopped. In this state, if the sheet surface detection sensor becomes in off-state by the sheets being removed from the sheet stacking tray 15 as shown in FIG. 14A, the sheet stacking tray 15 is lifted up after a predetermined time has elapsed (after 3 seconds in the present embodiment) until the sheet surface detection sensor Sn3 becomes in on-state (see FIG. 14B). In this case, the sheet pressing paddle 50 is not downwardly directed and even if the sheet stacking tray 15 is lifted up, it does not get caught in the gap 11b. Therefore, the sheet stacking tray 15 is lifted up all at once.

As described above, while a plurality of sheet bundles composed of predetermined sheets are being continuously discharged, and in case the sheet bundle stacked on the stacking surface 15a is removed such that the paddle portion 50b of the sheet pressing paddle50 at the pressing position becomes separated from the stacking surface15a, the sheet stacking tray 15 is not lifted all at once.

Instead, in accordance with a command to rotate the sheet pressing paddle 50, the stacking tray 15 is lifted stepwise by a predetermined amount.

This stepwise lifting operation prevents the sheet pressing paddle 50 from entering the gap 11b and becoming unable to rotate, thereby ensuring that an accurate sheet discharge operation is executed.

In the above-described embodiment, it is judged whether the sheet surface detection sensor Sn3 becomes in on-state or in off-state, namely, whether a sheet bundle is removed from the sheet stacking tray 15 or not each time one sheet bundle is discharged (step S5). However, in sheet bundles each having a small number of sheets bound by the biding process, it can be judged each time a plurality of sheet bundles are discharged.

The above-described embodiment is exemplified by stapled sheet bundles being discharged. However, the invention can be applied likewise to the case where non-stapled sheets are discharged one by one on to the sheet stacking tray 15. Similar to the case where sheet bundles having a small number of sheets, in this case, the sheet removal judgement in step S5 in FIG. 8 can be performed each time a plurality of sheets (for example 15 sheets) are discharged.

In the above-described embodiment, the removal of the sheets is judged by the on-state or off-state of the sheet surface detection sensor Sn3. However, the judgement of sheet removal can be performed by another way. For example, a sensor different from the sheet surface detection sensor Sn3 can be provided to detect a sheet surface. When this sensor becomes in off-state, it can be judged that sheets are removed from the sheet stacking tray 15.

In the above-described embodiment, the sheet processing apparatus B is disposed in the inner space 4c of the image forming apparatus A. However, the sheet processing apparatus can be attached to a side surface of an image forming apparatus. Further, the sheet processing apparatus can be configured to be controlled by the image forming control portion 200 of the image forming apparatus A. Namely, the control portion can be provided in the sheet processing apparatus or in the image forming apparatus as long as the control portion can control the sheet processing apparatus in the image forming system.

In the above-described embodiment, one possible condition under which the paddle portion 50b becomes caught in the gap 11b is that the sheet pressing paddle 50 has been rotated a predetermined number of times or more, causing wear at the tip of the paddle portion 50b. This wear may make the paddle portion 50b more susceptible to bending, resulting in it becoming caught in the gap 11b.

Therefore, the “discharge-after-removal mode,” in which the rotation of the sheet pressing paddle 50 and the stepwise lifting of the sheet stacking tray 15 by a predetermined amount are repeated, may be executed after the sheet pressing paddle 50 has been rotated a predetermined number of times (e.g., 100,000 times).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-190440, filed on October 30,2024, which is hereby incorporated by reference herein in its entirety.

What is claimed is:

1. A sheet processing apparatus comprising:
a binding portion configured to perform a binding process to a sheet bundle;
a discharge portion configured to discharge the sheet bundle binded by the binding portion;
a stack tray having a stacking surface configured to stack the sheet bundle discharged by the discharge portion;
an abutting surface configured to receive one end of the sheet bundle discharged onto the stacking surface
a sensor configured to detect a height of an uppermost sheet of a sheet bundle stacked on the stacking surface;
a lifting mechanism configured to lift up and down the stack tray such that the height of the uppermost sheet of a sheet bundle on the stacking surface falls within a predetermined range, based on an output of the sensor;
a pressing member having a contact portion configured to elastically deform and contact an upper surface of the sheet bundle abutted against the abutting surface, and configured to rotate to a pressing position to press the upper surface of the sheet bundle;
a rotating mechanism configured to rotate the pressing member;
a control unit configured to control the lifting mechanism and the rotating mechanism;
wherein the control unit is capable of executing control such that, while a plurality of sheet bundles composed of predetermined sheets are being continuously discharged, and in case the sheet bundle stacked on the stacking surface is removed such that the contact portion of the pressing member at the pressing position becomes separated from the stacking surface,
the stack tray is repeatedly lifted by a predetermined amount in accordance with a command to rotate the pressing member, such that the height of the uppermost sheet of the sheet bundle on the stacking surface falls within a predetermined range, in order to prevent the pressing member from being sandwiched between the stack tray and the abutting surface.

2. An image forming system comprising:
an image forming portion configured to form an image on a sheet;
a binding portion configured to perform a binding process to a sheet bundle composed of sheets on which an image has been formed by the image forming portion;
a discharge portion configured to discharge the sheet bundle binded by the binding portion;
a stack tray having a stacking surface configured to stack the sheet bundle discharged by the discharge portion;
an abutting surface configured to receive one end of the sheet bundle discharged onto the stacking surface
a sensor configured to detect a height of an uppermost sheet of a sheet bundle stacked on the stacking surface;
a lifting mechanism configured to lift up and down the stack tray such that the height of the uppermost sheet of a sheet bundle on the stacking surface falls within a predetermined range, based on an output of the sensor;
a pressing member having a contact portion configured to elastically deform and contact an upper surface of the sheet bundle abutted against the abutting surface, and configured to rotate to a pressing position to press the upper surface of the sheet bundle;
a rotating mechanism configured to rotate the pressing member;
a control unit configured to control the lifting mechanism and the rotating mechanism;
wherein the control unit is capable of executing control such that, while a plurality of sheet bundles composed of predetermined sheets are being continuously discharged, and in case the sheet bundle stacked on the stacking surface is removed such that the contact portion of the pressing member at the pressing position becomes separated from the stacking surface,
the stack tray is repeatedly lifted by a predetermined amount in accordance with a command to rotate the pressing member, such that the height of the uppermost sheet of the sheet bundle on the stacking surface falls within a predetermined range, in order to prevent the pressing member from being sandwiched between the stack tray and the abutting surface.
